(19) United States
(12) Patent Application Publication
(10) Pub. No.: US 2001/0054059 A1
(43) Pub. Date: Dec. 20, 2001

(54) Opt-in electronic mail advertising for internet radio network

(76) Inventors: Michael B. Marks, South Orleans, MA (US); Joel Marks, Sherman Oaks, CA (US)

Correspondence Address: Brad I Golstein, Metro88 Partnership, 20755 Plummer Street, Chatsworth, CA, 91311, US

(21) Appl. No.: 09/752,762

(22) Filed: Jan. 3, 2001

Related U.S. Application Data
(60) Provisional application No. 60/209,963, filed on Jun. 8, 2000.

(51) Int. Cl. G06F 15/16

(52) U.S. Cl. 709/201

(57) ABSTRACT

A subscription system for the receipt of infotainment content such as audio programming is disclosed. A network operator enables a user to elect to pay a fee or to agree to receive email-advertising messages for continuing permission to access content. If email ads are elected, the ads are sent to the user's email address in a separate time and/or space from the content. The email ads are linked by at least one of subject and occurrence to the user's activities in accessing content. A user ID identifiable to the network operator links the email ads and content accessed by the user. The email ads are sent to a user system that may be disconnected from the system that provides the user's infotainment experience. The email ads may be sent as a single message under a subject heading, or as part of a bundle of ads combined under a single subject heading. Bundled ads are normally individually less costly to advertisers than single ads.

### FIELD OF THE INVENTION

The present invention relates to payment systems for ongoing access to content. More precisely the present invention pertains to a method of subscription that may be used in conjunction with Internet Radio (“IR”) and other content in the form of fees or by the receipt of electronic mail (“e-mail”).

### BACKGROUND OF THE INVENTION

E-mail has become a well-established method for Internet advertising. U.S. Pat. No. 6,014,502 to Moraes, assigned to Juno Online Services LP discloses an example of this advertising method. In preferred embodiments, the advertising is targeted to a user. U.S. Pat. No. 5,918,014 to Robinson, assigned to Athenium, L.L.C. discloses a means of automated collaborative filtering that may be used for such targeting. The advertising message may be contained within the text of the e-mail itself or it may come in the form of an attachment. U.S. Pat. No. 5,794,210 to Golhaber et al. and assigned to Cybergold discloses an attention brokerage including a method of orthogonal sponsorship whereby a user is compensated for inviting advertising that is delinked from benefits that may be purchased with the compensation. U.S. Pat. No. 5,974,398 to Hanson et al. discloses a method of presenting bids to a user for the user's attention, where a user's response earns credits for later use.

E-mail is a personal and professional communications medium; Internet mores frown upon the use of untargeted advertising known as “spam”. Therefore, advertisers wishing to utilize this medium typically ask a user's permission by offering a means for opting in or opting out of receiving such advertising. Targeted “opt-in” e-mail advertising offers the greatest benefits with the least intrusion. The targeting can be highly precise if the advertiser utilizes personal profile information and/or collaborative filtering technologies. In theory a single user can be targeted for a single ad. Targeting enables a user (the recipient) to receive advertising that is relevant to him or her. Opting-in (or out) gives the user control.

Terrestrial Broadcast Radio (“TBR”) provides minimal targeting by means of station genre. For example, at its most targeted, a Country music station might advertise concert tickets for Country singer Randy Travis or a new sort of horse shampoo. The TBR Country station has no way of knowing if a given listener likes Randy Travis or owns a horse. By contrast, an Internet Radio station (“IR”) may track a user's Internet listening and viewing habits and come to know such things. Thus the IR station may deliver better-targeted advertising than the TBR station.

Audio advertising inserted into programming is commonly used by TBR to pay for content. IR stations such as Discjockey.com, Launch.com and Netradio.com, typically use a combination of methods including audio advertising, banner advertising and e-commerce to pay for content. Cybergold.com may compensate a user with cash for listening to radio programming that includes ads, in accordance with the orthogonal sponsorship of U.S. Pat. No. 5,794,210.

Audio advertising interrupts programming. Even targeted audio advertising may thus be found unpleasant. A user wishing to avoid such advertising typically changes channels. Users seeking content free of advertising interruptions may therefore be willing to pay fees in the form of subscriptions. For 2001, Sirius Satellite Radio and XM Satellite Radio have announced the introduction of subscription-supported, advertising-free audio content, supplied to users by means of satellites.

Goldhaber Patent '210 is typical of the prior art where a user is compensated for a specific decision to receive advertising. The receipt of the advertising and the use of the resulting compensation are disconnected or “unlinked”. The user makes a decision to receive advertising and then makes a further decision of how to apply the compensation.

As a method of paying for audio content, an advantage will be had if a user is provided an opportunity to maintain an explicit link in subject or occurrence between receipt of audio content and receipt of ads, although the ads may be received separately from the content. The ads can stay relevant to the user's experience of the audio content.

### SUMMARY OF THE INVENTION

The present invention includes a means for providing content free or reduced of audio interruptions by utilizing e-mail advertising delivered at a time and in a space that may be disconnected from the user's audio experience. The email advertising is linked to the user's receipt of content. According to a preferred embodiment of the invention the audio content is offered by a network of affiliated content providers. A user registering with the network is given a choice of paying for the content by means of subscription or by actively opting to receive targeted e-mail advertising. The content may comprise general multimedia programming including text or other displayed content which may optionally be made audible. If the user opts into the email payment method, subsequent payments occur automatically and passively as a reaction by the network operator to the user's access or likely anticipated access of content. Specifically the user receives email ads while the advertisers pay the content provider for email ads that have been delivered. The advertiser's payments normally pass through the network operator, but do not pass to or through the user since the payments serve only to pay for content that has been delivered or is likely to be delivered to the user.

The advertising may be targeted by use of personal profile information and/or by tracking a user's activities within the network. E-mail advertising subsequently delivered to the user may be batched by advertising subject matter and/or by network site such that multiple advertising messages may be contained within a single e-mail transmission. A user's previous habits of accessing programming may be used to select the type of ads that are sent as well as the quantity of ads that are sent. However delivery of ads may be curtailed if a user stops accessing programming.

### DESCRIPTION OF THE DRAWINGS

FIG. 1 is a flowchart showing a content payment system.

FIG. 2 is an exemplary bundled email advertisement.

### DETAILED DISCLOSURE OF THE PRESENT INVENTION

A preferred embodiment of the present invention comprises: 1) a group of one or more sites connected to each other and to users by means of a data communications network wherein each site contains information and entertainment content that is or may be made audible to users in conjunction with a software or hardware player that can render audible streaming audio data and/or stored audio data in conjunction with a digital audio device, wherein the sites share a common network operator; 2) a user connected to one of the sites on the network wherein the user utilizes a device enabled with a means to render audible a digital audio signal delivered to the user from one of the sites; 3) a registration means necessary for a user to gain initial access to the majority of the content on a site wherein the user is given the choice of either, a) paying a subscription fee for repeated and complete access to the content for a given period of time (“Fee User”) or b) the option to accept targeted e-mail advertising in lieu of paying the subscription fee (“Ad User”); 4) a means for receiving payment from a Fee User; 5) a means for recording user profile and e-mail address information from an Ad User whereby such information may enable the transmission and targeting of advertising messages; 6) a means for identifying a user to a site whereby the site may know whether the user is an Ad User a Fee User or an unregistered user; 7) a means for denying unregistered users access to the majority of the content at a site; 8) a means for tracking and recording the activities of an Ad User on a site or sites so that such activities may be correlated to advertising messages; 9) a means for sending an e-mail advertising message to an Ad User wherein the message is identified in the “subject heading” as emanating from a site visited by the user; and 10) a means for the network operator to know when an Ad User has responded to an e-mail advertising message delivered by a site. A site is a web site or equivalent outlet of a content provider.

As described above in items 8 and 9 an email ad is sent to an Ad User in response to or in reaction to a user having accessed a content site. A user is effectively “billed” through the common network operator for accessing content. The bill is by or on behalf of a site whose content has been accessed, or is likely to be accessed. The bill is in the form of email ads sent to the user. The Fee User may pay in advance for set time period, while the Ad User receives ads after or near to when content is accessed. The Fee User could also be charged after content is accessed as a fee for services rendered. A Fee User subscribes by direct cash payment while the Ad User subscribes by opting to receive email ads from advertisers.

Alternative embodiments of the present invention may utilize only some of the features described above. Likewise, alternative embodiments may incorporate additional features such as; 1) a common method for navigation within and among the sites such as that described in provisional patent application No. 60/193,372, “Audio Internet Navigation Method” by Marks and Marks, filed Mar. 31, 2000. This reference provides methods applicable to broader multimedia programming including the option that informational content may be text-only and not audible. Further embodiments of the present invention may include; 2) tools for enhancing the experience and utilization of the sites such as that described in provisional patent application No. 60/199,120, “Method for Assembly of Unique Playlists” by Marks, Marks and Lipman filed Apr. 24, 2000. The specifications of these provisional applications are incorporated herein by reference in their entirety.

The audio hardware devices and systems used in conjunction with the present invention may be personal computers, MP3 players, audio-enabled cellular telephones such as the Mobile Interactive Radio disclosed by Bottom in U.S. Pat. No. 6,014,569 and devices such as those offered by Sonicbox (www.sonicbox.com) and Kerbango (www.kerbango.com). These devices are not necessarily able to neither receive nor present email messages. However according to the invention the email may be received in a separate space from the user's audio experience. For example an email program on a personal computer may be used to receive and display email, while one of the above devices, or a separately running program on a personal computer, may be used to play audio programming. Although the playing experiences are separate spatially from the email application, the listener can still be linked to a provider of programming as an Ad User by means of a user ID assigned by the network operator.

The tracking process for Ad Users may comprise, 1) a cookie installed on the user's device (or devices) whereby a site may know the identity of the user and transmit information on the user's activities within the site to the network operator; 2) a site identity transmitted to the network operator upon contact by an Ad User wherein the user's ID and the site ID are joined in a record maintained by the network operator; 3) content identification from within the site wherein the user's ID and the content ID are joined in a record maintained by the network operator. The site ID and content ID may be correlated to key words and demographic information useful for targeting advertising messages. At a minimal level targeting comprises determining that a particular user has accessed content from a network affiliated site.

The utility of the e-mail advertising messages diminish to the user if they become intrusive—too many email advertising messages at one time might cause the user to delete or ignore all of them. Therefore the present invention may utilize concepts of bundling, timed release and maximum ad threshold to achieve the maximum utility for both user and advertiser.

Bundling is a tool whereby multiple e-mail advertising messages may be contained in a single e-mail transmission. In the preferred embodiment of this tool the multiple messages concern items that are both non-competitive (as defined by the network operator) and correlated to a similar set of activities. In the example in the Background section of the present disclosure,

Country music was correlated to Randy Travis concert tickets and to horse ownership. Thus an Ad User visiting a Country music site might receive messages on both items in a single e-mail transmission. Such an e-mail transmission could be identified to the user with an entry on the subject heading that said, “Messages from your Country music sponsors.” In this manner the Ad User will not be overloaded with multiple e-mail ads from individual advertisers and the network operator and sites may preserve and build a good, minimally, if not non-intrusive, relationship with the user. At the same time the network operator may allow advertisers to send users single, unbundled e-mail ad messages for a higher advertising rate—a higher cost for advertising delivery will correlate to better targeting and better targeting will correlate to higher user benefits—thus the user relationship may be preserved.

Bundling may be used when an Ad User visits multiple sites and retrieves or tunes into a variety of content. Using forms of collaborative filtering each site visited and each unique content element consumed may be used to create a profile for delivering a bundle of e-mail ads in a single e-mail transmission. The bundle could relate to a category of advertising such as travel or automotive. The bundle of ads would then be identified in conjunction with the network operator or a subject heading such as, “Messages on Travel from your Network.”

Timing the release of e-mail advertising messages may be desired so that an Ad User regularly receives a fewer number of messages from the network operator/network sites rather than a larger quantity of messages less periodically. The network operator may thus set an automated trigger that sends a bundled message after a waiting period of N minutes following aggregation of a complete bundle. The email messages is delivered to a user's email receiving device in response to or anticipation of the user receiving or “consuming” content.

The network operator may set a limit on the number of unique and bundled e-mail ad messages an Ad-User receives each day. Likewise the network operator may set a limit on the number of messages that may be bundled together in a single transmission. For example the network operator may set a maximum of twelve e-mail ad messages per day. Of the twelve per day maximum the operator may further set a ratio on how many are bundled messages and how many are unique messages. Further, a value may be assigned to the bundled messages, which in turn is used to set a minimum value for the unique messages. Likewise, the network operator may set a maximum number of words allowed for both bundled and unique messages.

For example, the network operator may set 1,000 words as the maximum allowable per message. Thus, if the maximum is set at 1,000 words and a bundled message costs $0.03 for a maximum of 250 words, a unique message may cost $0.12 for a maximum of 1,000 words.

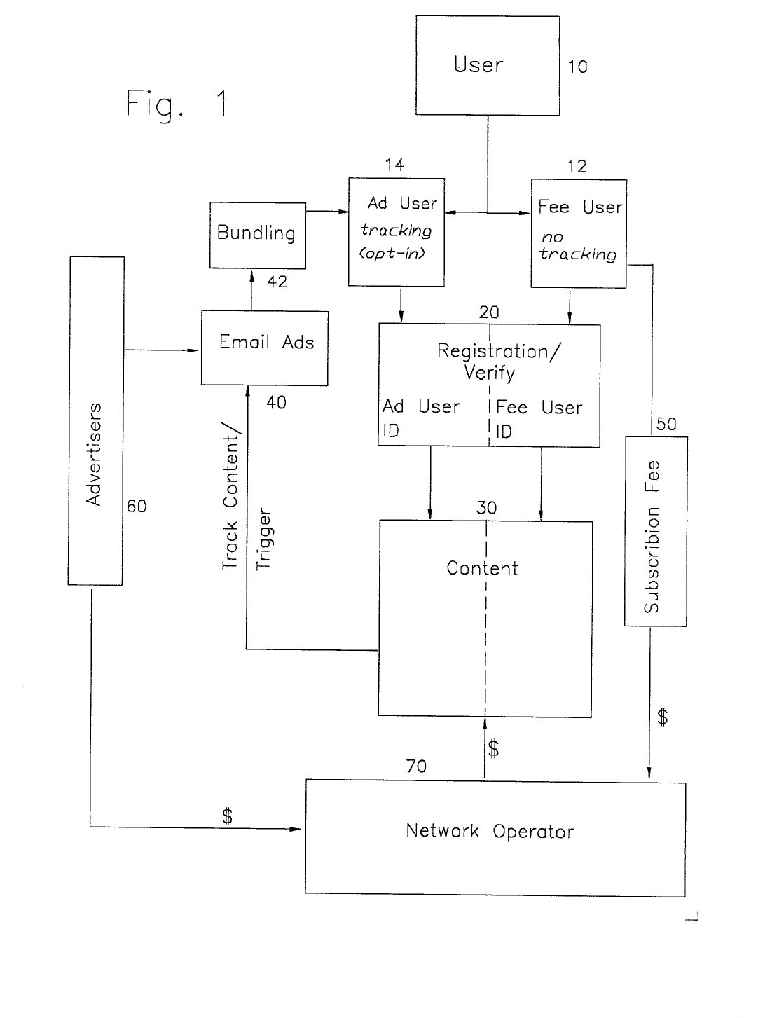

In FIG. 1 concepts according to the invention are illustrated. A user 10 is offered a choice between being an Ad User 14 or a Fee User 12. As an Ad User, user 14 agrees to allow the network operator to track his activities for the purpose of targeting advertising. A Fee User 12 may remain anonymous with respect to the identity of the programming he receives, whereby there is no tracking of his preferences. The Fee User pays out a subscription fee 50, or agrees to pay, to enable registration and verification of a user ID 20. Ad User 14 subscribes by opting in to receiving email ads to enable registration and verification of user ID 20. With the user ID user 10 becomes a subscriber with access to content 30.

Content 30 is linked to email ads 40 whereby the content selected by Ad User 14 may be tracked to influence the type of email ads 40 that are sent to Ad User 14. If preference tracking is not performed, the access of content 30 at least serves to trigger sending email ads. Advertisers 60 supply email ads 40 for distribution to Ad Users 14 as allowed by the network operator The network operator or the advertisers may select certain ads for bundling 42, depending on the advertising rate selected by advertisers 60 or user ad tolerance as determined by the network operator. Email ads 40 are delivered to Ad User 14. According to FIG. 1 permission to access programming content is granted either by opting into receipt of targeted email ads or by paying a fee. The email ads are delivered in response to the user accessing content; if the Ad User stops accessing content 30 the link between the user and the email ads is broken and email ads cease about that time or shortly thereafter.

The network operator receives income from one or both of fee payments 50 or advertisers 60. The network operator pays content providers 30 as users 12 and/or 14 access content from network-affiliated sites. Other known means for generating income may be used in combination with subscription by fee or email ads, such as audio ad inserts in audio content or display ads in text or graphical content.

Content 30 need not be limited to programmed audio infotainment. Content 30 may include text and graphics and video entertainment and information delivered to wired and wireless platforms in conjunction with the Internet. Content 30 may also comprise traditional media and entertainment events and a wide range of services, including, but not limited to, daily newspapers, monthly magazines, cable television, pay per view television, movie rentals, theater tickets, sports events, concerts, subscription radio services, club memberships and the like. In each case an Ad User's ID is linked to a selected provider of content by the network operator. The present invention enables opt-in e-mail advertising to pay for such offerings in a manner that builds the user's relationship with a content provider.

Of course an Ad User may, in the conventional way, opt to or be invited to accept advertising that is unlinked from the content. Such unlinked advertising can be used for accumulating benefits that are subsequently spendable. However according to the invention the user is not distinctly compensated for receiving email ads, rather as in FIG. 1 the email ads and the content are part of a closed loop feedback subscription system where access of content triggers the receipt of email ads, and payments from advertisers to content providers by way of the network operator. The advertisers are substantially directly sponsoring the delivery of content. However in contrast with audio insertions or display ads, the email ads do not clutter the user's experience of content.

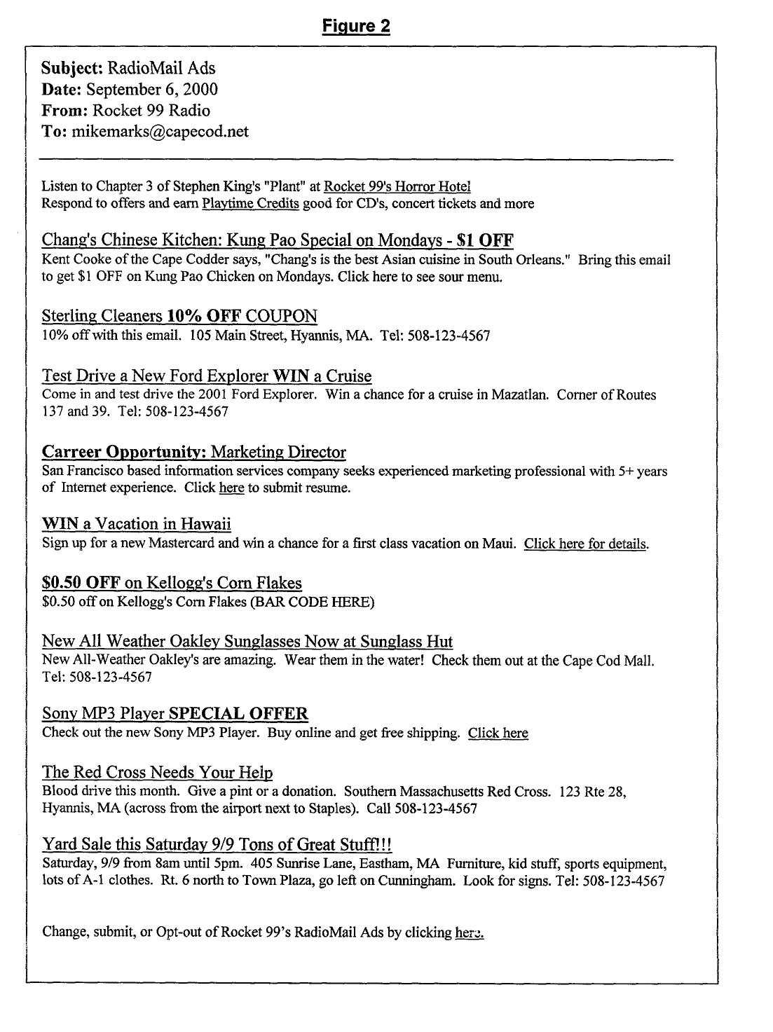

FIG. 2 shows an exemplary bundled email ad. The subject heading reads ““RadioMail Ads”. This identifies the ads as relating to the network or content provider to which the user has subscribed. In this example the content is primarily audio in nature. The “from” heading shows the name of the network operator, “Rocket 99 Radio” in the example. The individual ads that are bundled in the email message are from non-competing sponsors in the example. They are selected on the basis of stated preferences from the user or habits of the user in selecting programming. The user in this case has provided a zip code or other location information during registration as an Ad User 14 in FIG. 1. Therefore some of the emails are targeted to a user in a particular area of Cape Cod MA. Others are of a more general nature while some, such as the Career opportunity and yard sale may be in response to the user's specific request to receive such information. The email ads provide a variety of targeted information that is conveniently organized within a standardized format, all under a single subject heading. Optionally the ads under the single subject may all be directed to a common aspect of the subject, as in the Country music example above. The ad display of FIG. 2 will comprise a single item in the user's inbox. The ads are linked by at least one of subject and occurrence to a user's decision to access programming content from network affiliated sites.

Each email preferably includes an opportunity to change or opt out of the email program, as seen at the bottom of FIG. 2. A user may for example add or remove the request for information about yard sales, or place an ad for a used bicycle to be sent to other Ad Users in the affiliated network. If a user acts to opt out of the email program he will no longer be a subscriber with access to the majority of content from affiliated sites unless he instead pays the cash subscription fee.

The payment system of the present invention may be used for other programming content such as for subscription to video programming or electronic books. For example an Ad User's request and receipt of a chapter of an electronic book could trigger the sending of email ads to the user's email address, where opting out of receiving more such ads could deny the user access to further chapters.

Although the present invention has been described in a preferred embodiment, modifications may be anticipated without departing from the spirit and scope of the invention as claimed herein.

1. A subscription system for the receipt of content by a user where the content is delivered by means of a data network, the system comprising:
a user being offered an opportunity to register with a network operator to become entitled to receive content from content providers affiliated with the network operator, a registration process including an option to be an Ad User by electing to receive advertising that benefits the network operator via email, the email comprising advertising messages that are sent to an email address provided by the user to the network operator;
the advertising being sent on behalf of advertisers;
the advertisers paying the content providers as the user receives content from the content providers, the email advertising being linked by at least one of subject and occurrence to the user's access of content;
the email messages being received by the user separately from the content.

2. The subscription system of claim 1 wherein the email messages are targeted, a subject of the email messages being at least partially determined by a personal profile of the user.

3. The subscription system of claim 2 wherein the content comprises audio programming.

4. The subscription system of claim 3 wherein audio advertising is inserted into the content.

5. The subscription system of claim 3 wherein the content is streamed over a data network as digital information and the digital information is made audible by a player device.

6. The subscription system of claim 3 wherein the content is stored as digital information and the digital information is made audible by a player device.

7. The subscription system of claim 1 wherein the registration process includes an option to be a Fee User by electing to pay a fee that benefits the network operator.

8. The subscription system of claim 1 wherein a plurality of email messages are bundled under a common single subject heading.

9. The subscription system of claim 8 wherein the plurality of email messages are paid for by a plurality of sponsors.

10. The subscription system of claim 9 wherein the plurality of email messages are directed to the common single subject in the subject heading.

11. The subscription system of claim 8 wherein the plurality of email messages are non-competitive with respect to each other.

12. The subscription system of claim 1 wherein the advertisers pay the content providers indirectly, the advertiser first paying the network operator and the network operator then paying the content providers.

13. A system of subscription for content comprising:
a user being offered an opportunity to register with a network operator to become entitled to receive content, a registration process including an option to be an Ad User by electing to receive advertising that benefits the network operator, the advertising being in the form of email advertising messages sent to an email address provided by the user to the network operator;
the email messages being received by the user separately from the content;
advertisers paying content providers as the user receives content from the content providers.

14. The subscription system of claim 13 wherein the email messages are targeted, a subject of the email messages being at least partially determined by a personal profile of the user;
an ID of the content being joined with an ID of the Ad User in a record maintained by the network operator.

15. The subscription system of claim 13 wherein an occurrence of the email advertising is linked to an occurrence of the user's access of content.

16. The subscription system of claim 13 wherein the content comprises audio infotainment and the email messages are received on a system that is distinct from a system that is used to play the content.

17. The subscription system of claim 13 wherein the content comprises displayed infotainment and the email messages are received on a system that is distinct from a system that is used to display the content.

18. The subscription system of claim 13 wherein a plurality of email messages are bundled under a common single subject heading.

19. The subscription system of claim 18 wherein the plurality of email messages are paid for by a plurality of sponsors.

20. The subscription system of claim 18 wherein the plurality of email messages are non-competitive with respect to each other.

21. The subscription system of claim 18 wherein one of the plurality of email messages carries a lower advertising rate than a rate for a single, unbundled email message under a subject heading equivalent to the common subject heading.

22. The subscription system of claim 13 wherein the email message includes a link to enable the Ad User to send an ad to other Ad Users.
